(19) United States
(12) Patent Application Publication
(10) Pub. No.: US 2026/0346769 A1
(43) Pub. Date: Nov. 5, 2026

(54) COVER FOR COVERING A BLOCK OF ELASTICALLY COMPRESSIBLE PADDING FOR A MOTOR VEHICLE SEAT CUSHION

(71) Applicant: TESCA PACIFIC, Cedex (FR)

(72) Inventors: Aguilera MODESTO, Cedex (FR); Sergio PERIANES, Cedex (FR)

(21) Appl. No.: 19/139,487

(22) PCT Filed: Dec. 15, 2023
(86) PCT No.: PCT/EP2023/086209

§ 371 Date: Jun. 16, 2025

(30) Foreign Application Priority Data
Dec. 16, 2022 (FR) FR2213665

(51) Int. Cl. B60N 2/58; B60N 2/64

(52) U.S. Cl. CPC B60N 2/5825; B60N 2/646

(57) ABSTRACT

The invention relates to a cover (1) for covering a block (2) of elastically compressible padding for the upholstery (11) of a motor vehicle seat (3), the said cover being based on a textile knitted with a first thermoplastic yarn, the said cover being provided with at least one anchoring element (4) obtained by knitting the said cover so as to be formed partly from the said first yarn, said anchoring element further comprising a second thermoplastic yarn knitted with said first yarn, said second yarn having a lower melting point than said first yarn, said second yarn having been melted so that said anchoring element is composed of said first yarn in the unmelted state and said second yarn in the melted state, said anchoring element being stiffened by the melting of said second yarn.

The invention relates to a cover for covering a block of elastically compressible padding for a motor vehicle seat cushion, a cushion comprising such a cover, a seat comprising such a cover and a method for producing such a cover.

It is known to produce a cover for covering a block of elastically compressible padding for a motor vehicle seat cushion, said cover being based on a fabric knitted with a first thermoplastic yarn, said cover being provided with at least one anchoring element intended to hook onto a complementary anchoring element coming from said block or from a frame of said seat to ensure a return of said cap towards said block.

One advantage of knitting a cover is that it can be given a three-dimensional shape that matches the shape of the padding block, thus avoiding or limiting the need for sewing operations to join together a plurality of covering material formats.

In addition, the presence of anchoring elements allows to ensure that the cover is fixed to the padding block and/or to the frame, while allowing it to be pressed against said block, particularly in concave areas.

Usually, an anchoring element is associated with the cover by a fastening means such as a seam, which complicates its manufacturing.

Furthermore, the integration of the anchoring element in the cover may be visible on its appearance side, which is unsightly.

The aim of the invention is to overcome these drawbacks.

To that end, and according to a first aspect, the invention proposes a cover for covering a block of elastically compressible padding for a motor vehicle seat cushion, said cover being based on a fabric knitted with a first thermoplastic yarn, said cover being provided with at least one anchoring element intended to hook onto a complementary anchoring element coming from said block or from a frame of said seat to ensure a return of said cover towards said block, said cover having the following characteristics:
said anchoring element results from knitting said cover so that it is formed in part from said first yarn,
said anchoring element further comprises a second thermoplastic yarn knitted with said first yarn, said second yarn having a lower melting point than said first yarn,
said second yarn has been melted so that said anchoring element is made up of said first yarn in a non-molten state and said second yarn in a molten state, said anchoring element being stiffened by the melting of said second yarn.

With the proposed arrangement, as the anchoring element is produced by knitting the cover, manufacturing thereof is simplified, in particular by avoiding the need for sewing.

In addition, the anchoring element is not visible from the appearance side of the cover.

Finally, the second yarn in the molten state creates a crust that allows to stiffen the anchoring element, ensuring good anchoring capacity and great strength to said element.

According to other aspects, the invention proposes a padding comprising such a cover, a seat comprising such a cover and a method for producing such a cover.

Further features and advantages of the invention will become apparent from the following description, made with reference to the attached figures, in which:

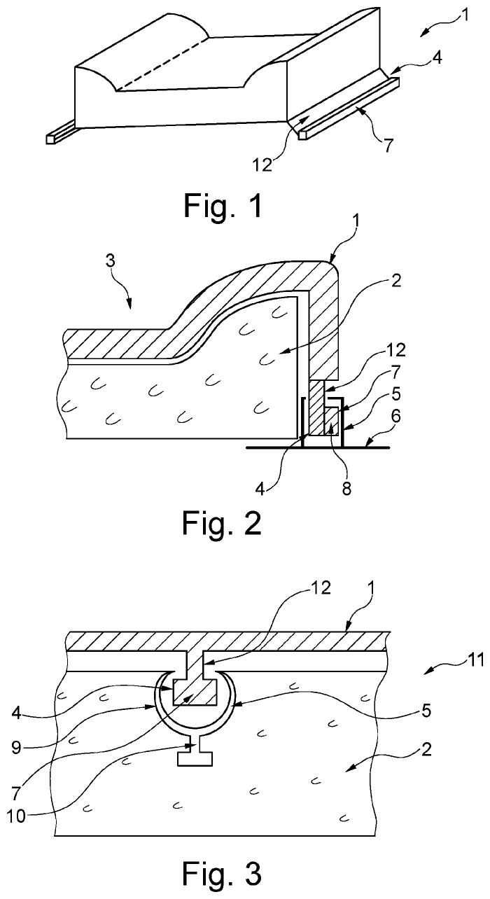

FIG. 1 is a schematic perspective view of a cover provided with a peripheral anchoring element, according to one embodiment,

FIG. 2 is a schematic partial cross-sectional view of a seat provided with the cover shown in FIG. 1,

FIG. 3 is a schematic partial cross-sectional view of a padding provided with a cover comprising a non-peripheral anchoring element, according to one embodiment.

With reference to the figures, we describe a cover 1 for covering a block 2 of elastically compressible padding for a cushion 11 of a motor vehicle seat 3, said cover being based on a fabric knitted with a first thermoplastic yarn—for example polyester—, said cover being provided with at least one anchoring element 4 intended to hook onto a complementary anchoring element 5 coming from said block or from a frame 6 of said seat to ensure a return of said cover towards said block, said cover having the following characteristics:
said anchoring element results from knitting said cover so as to be formed in part from said first yarn,
said anchoring element further comprises a second thermoplastic yarn—e.g. polyester modified to lower its melting point—knitted with said first yarn, said second yarn having a lower melting point than said first yarn,
said second yarn has been melted so that said anchoring element is made up of said first yarn in a non-molten state and said second yarn in a molten state, said anchoring element being stiffened by the melting of said second yarn.

According to the embodiment shown in FIGS. 1 and 2, an anchoring element 4 is arranged around the periphery of the cover 1, in particular so as to anchor it to a metal frame 6 of the seat, as will be seen below.

In the embodiment shown, the anchoring element 4 extends along a whole side of the cover 1.

According to the embodiment shown in FIG. 3, an anchoring element 4 is arranged outside the periphery of the cover 1, in particular to anchor it to the padding block 2 of the cushion 11 of the seat 3, as will be seen later.

Such an arrangement enables the cover 1 to be returned towards the padding block 2 in non-peripheral areas, particularly in concave areas, so as to avoid poaching of said cover.

According to the embodiments shown, an anchoring element 4 has a thin zone 12 and a beaded zone 7 extending along its free edge, said beaded zone forming an anchoring portion.

In the embodiment shown in FIG. 2, the beaded area 7 is provided with a co-knitted overlayer 8.

According to the embodiment shown in FIG. 2, the thin zone 12 is has a lower thickness than the part of the cover 1 that is adjacent to the anchoring element 4, while the beaded zone 7 has a thickness similar to that of said cover part.

Referring to FIG. 3, we now describe a cushion 11 for a motor vehicle seat 3 comprising such a cover 1, said cushion further comprising a block 2 of elastically compressible padding, said cover being fitted over said block, said block being provided with at least one complementary anchoring element 5 hooking onto an anchoring element 4 so as to return said cover towards said block.

According to the embodiment shown in FIG. 3, a complementary anchoring element 5 comprises a generally Ω-shaped, elastically deformable hooking portion 9 which is arranged to allow the anchoring element 4 to be forcibly inserted therein and held in said hooking portion.

According to the embodiment shown in FIG. 3, the padding block 2 is based on molded foam, a complementary anchoring element 5 comprising a fastening portion 10 in the foam, said portion being overmolded by said block.

Referring to FIG. 2, we now describe a motor vehicle seat 3 comprising a cover 1 provided with an anchoring element 4 arranged around its periphery and a block 2 on which said cover is fitted, said seat further comprising a metal frame 6 provided around its periphery with a complementary anchoring element 5—here the form of a groove—receiving said anchoring element.

Finally, a method for producing such a cover 1 is described, said cover comprising the following steps:
knitting a cover 1 with a first thermoplastic yarn, said cover being provided with at least one anchoring element 4 resulting from knitting said cover, said knitting further using at said element a second thermoplastic yarn having a lower melting point than said first yarn;
heating said cover—in particular in an oven—to a temperature greater than the melting temperature of said second yarn and lower than the melting temperature of said first yarn, so as to melt said second yarn to stiffen said anchoring element.

1. Cover (1) for covering a block (2) of elastically compressible padding for a cushion (11) of a motor vehicle seat (3), said cover being based on a fabric knitted with a first thermoplastic yarn, said cover being provided with at least one anchoring element (4) intended to hook onto a complementary anchoring element (5) coming from said block or from a frame (6) of said seat in order to ensure a return of said cover towards said block, said cover being characterized in that:
said anchoring element results from knitting said cover so that it is formed in part from said first yarn,
said anchoring element further comprises a second thermoplastic yarn knitted with said first yarn, said second yarn having a lower melting point than said first yarn,
said second yarn has been melted so that said anchoring element is composed of said first yarn in a non-molten state and said second yarn in a molten state, said anchoring element being stiffened by the melting of said second yarn.

2. Cover (1) according to claim 1, characterized in that an anchoring element (4) is arranged on the periphery of said cover.

3. Cover (1) according to claim 1, characterized in that an anchoring element (4) is arranged outside the periphery of said cover.

4. Cover (1) according to claim 1, characterized in that an anchoring element (4) has a thin zone (12) and a beaded zone (7) extending along its free edge, said beaded zone forming an anchoring portion.

5. Cover (1) according to the claim 4, characterized in that the beaded area (7) is provided with a co-knitted overlayer (8).

6. Motor vehicle seat cushion (11) comprising a cover (1) according to claim 1, said cushion further comprising a block (2) of elastically compressible padding, said cover being fitted over said block, said block being provided with at least one complementary anchoring element (5) hooking onto an anchoring element so as to return said cover towards said block.

7. Cushion (11) according to claim 6, characterized in that a complementary anchoring element (5) comprises a generally Ω-shaped elastically deformable hooking portion (9) that is arranged so as to allow the anchoring element (4) to be forcefully inserted therein and held in said hooking portion.

8. Cushion (11) according to claim 6, characterized in that the padding block (2) is based on molded foam, a complementary anchoring element (5) comprising a fixing portion (10) in the foam, said portion being overmolded by said block.

9. Motor vehicle seat (3) comprising a cover (1) according to claim 2 and a block (2) on which said cover is fitted, said seat further comprising a metal frame provided at its periphery with a complementary anchoring element (5) receiving an anchoring element (4).

10. A method for producing a cover (1) according to claim 1, said method comprising the following steps:
knitting a cover (1) with a first thermoplastic yarn, said cover being provided with at least one anchoring element (4) resulting from knitting said cover, said knitting further using at said element a second thermoplastic yarn having a lower melting point than said first yarn;
heating said cover to a temperature greater than the melting temperature of said second yarn and lower than the melting temperature of said first yarn, so as to melt said second yarn to stiffen said anchoring element.
